(19) United States
(12) Patent Application Publication
(10) Pub. No.: US 2005/0049847 A1
(43) Pub. Date: Mar. 3, 2005

(54) Software development environment and method for measuring software performance

(75) Inventors: Satoshi Miyamoto, Ishi-Kaua (JP); Yuji Honda, Tokyo (JP); Yasuhiro Miyazaki, Miyazaki (JP); Hiroshi Kume, Tokyo (JP)

Correspondence Address: VENABLE, BAETJER, HOWARD AND CIVILETTI, LLP, P.O. BOX 34385, WASHINGTON, DC, 20043-9998, US

(73) Assignee: Oki Electric Industry Co., Ltd., Tokyo (JP)

(21) Appl. No.: 10/650,993

(22) Filed: Aug. 29, 2003

(51) Int. Cl. G06F 9/45; G06F 9/44

(52) U.S. Cl. 703/22; 717/101; 717/124; 717/154

(57) ABSTRACT

Software development environment includes a development board; an electronic processor based device which is mounted on the development board and is adapted to execute a series of software instructions; and a host computer which is combinable with the electronic processor based device. The host computer executes both benchmark test software and software under development on an operating system to calculate a first benchmark value of the electronic processor based device. The software under development is executed preferentially. The host computer calculates the residual capability of the electronic processor based device in accordance with the first benchmark value.

### TECHNICAL FIELD OF THE INVENTION

The present invention generally relates to software development environment and method for analyzing software performance under development.

### BACKGROUND OF THE INVENTION

Software performance measurement refers to examining the execution times, etc. of different software procedures within a software program. Performance analyzer can be a very useful tool to a software engineer attempting to optimize the execution times of software applications.

The growth in software complexity, coupled with increasing processor clock speeds, has placed new burdens on application software developers and complicated the task of performance profiling. Logic analyzers, read-only memory (ROM) emulators and in-circuit emulators (ICE) are generally used to capture software performance profiling data.

Generally, a client or customer who ordered development of software has big concern in the ability to be incorporated what functions to the software under development. It is rare that software development is concluded only in a software developing company based on the specification defined beforehand. Usually, the customer and software developing company examine specification mutually. A customer wants to add some new functions to the software as much as possible. Then, it may analyze how much the software under development occupies CPU, and the processing capability of CPU may examine what function can newly be incorporated relied on the analyzing result.

A conventional software development environment includes a host computer; a development board; an embedded CPU mounted on the circuit board; and a logic analyzer. Under this development environment, a processing time of task is measured when the software under development is processed as a task. The logic analyzer is connected to the host computer through a RS232C cable. Probes of the logic analyzer are connected to pins of the embedded CPU.

When software for timing measurement installed in the computer is executed, the tracking waveform which consists of 1 and 0 is observed. The waveform record is stored on a memory, and operating time of the CPU is summed through the waveform. The processing time of the software can be calculated from the operating time of the CPU.

However, according to the above-described conventional development environment, the processing time of the task is measured when the software under development is processed as a task; and therefore, it is required to track waveforms by the logic analyzer. The summation and calculation of the processing time is complicated.

Another conventional software development environment includes a host computer; a development board; a logic analyzer connected to the environment circuit board; an embedded CPU mounted on the environment circuit board; and an In-circuit emulator connected between the host computer and the embedded CPU. The ICE (In-Circuit Emulator) is connected through a parallel interface to the host computer. The ICE is also connected to the development circuit board through a JTAG (Joint Test Action Group) interface.

The logic analyzer (LA) is combinable with the development circuit board through a bus AMBA (Advanced Micro-controller Bus Architecture). When processing the software under development as a task in this development environment, there are two methods in measurement of the processing time. One is a method using the logic analyzer as usual. Another method is a method of running a software development tool (Software Development Toolkit) on the host computer, and measuring the benchmark of the CPU.

However, according to the above-described conventional environment, the system (development environment) would be expensive. It is hard to know the residual (remaining) capability of the CPU relative to the entire capability of the CPU. There, the benchmark of CPU only shows the relative capability thereof when executing the software under development.

### OBJECTS OF THE INVENTION

Accordingly, an object of the present invention is to provide a software development environment under which the residual (remaining) of CPU can be evaluated precisely and easily.

Another object of the present invention is to provide a method in which the residual (remaining) capability of CPU under development environment can be evaluated precisely and easily.

The objects and advantages of the invention may be realized and attained by means of the instrumentalities and combinations particularly pointed out in the appended claims.

### SUMMARY OF THE INVENTION

According to a first aspect of the present invention, a software development environment includes a development board; an embedded CPU device with CPU core which execute a series of software instructions; and a host computer which is combinable with the electronic processor based device. The host computer executes both benchmark test software and software under development on an operating system to determine a first benchmark value of the electronic processor based device. The host computer determine the residual capability of the electronic processor based device in accordance with the first benchmark value. the software under development is executed preferentially.

Preferably, the host computer solely executes the benchmark test software to calculate a second benchmark value of the electronic processor based device. In this case, the host computer may calculate an amount of new functions that can be added to the software under development in accordance with the first and second benchmark values.

According to a second aspect of the present invention, both benchmark test software and software under development are executed on the same operating system to determine a first benchmark value of an electronic processor based device, mounted on a development circuit board. The residual capability of the electronic processor based device is calculated in accordance with the first benchmark value.

Preferably, the benchmark test software is solely executed to calculate a second benchmark value of the electronic processor based device. In this case, an amount of new functions that can be added to the software under development is calculated in accordance with the first and second benchmark values.

### BRIEF DESCRIPTION OF THE DRAWINGS

FIG. 1 is a diagram showing a conventional software development environment.

FIG. 2 is a diagram showing another conventional software development environment.

FIG. 3 is a diagram showing a software development environment according to a preferred embodiment of the present invention.

FIG. 4 is a diagram showing an address architecture or configuration of a CPU used in the software development environment shown in FIG. 3.

FIG. 5 is a diagram showing steps for evaluating the performance of the software under development.

### DETAILED DISCLOSURE OF THE INVENTION

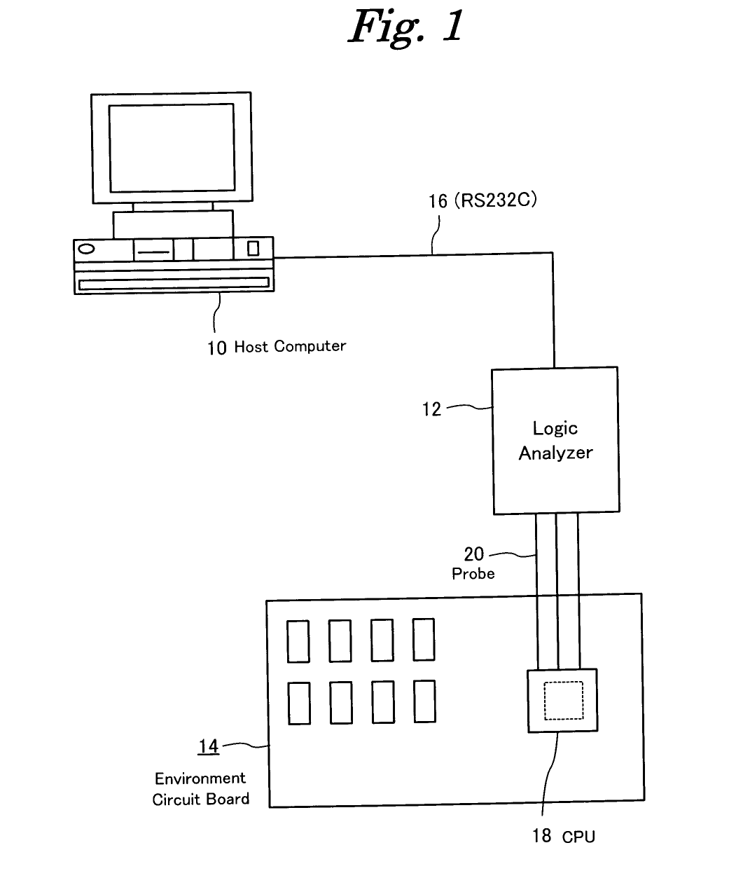

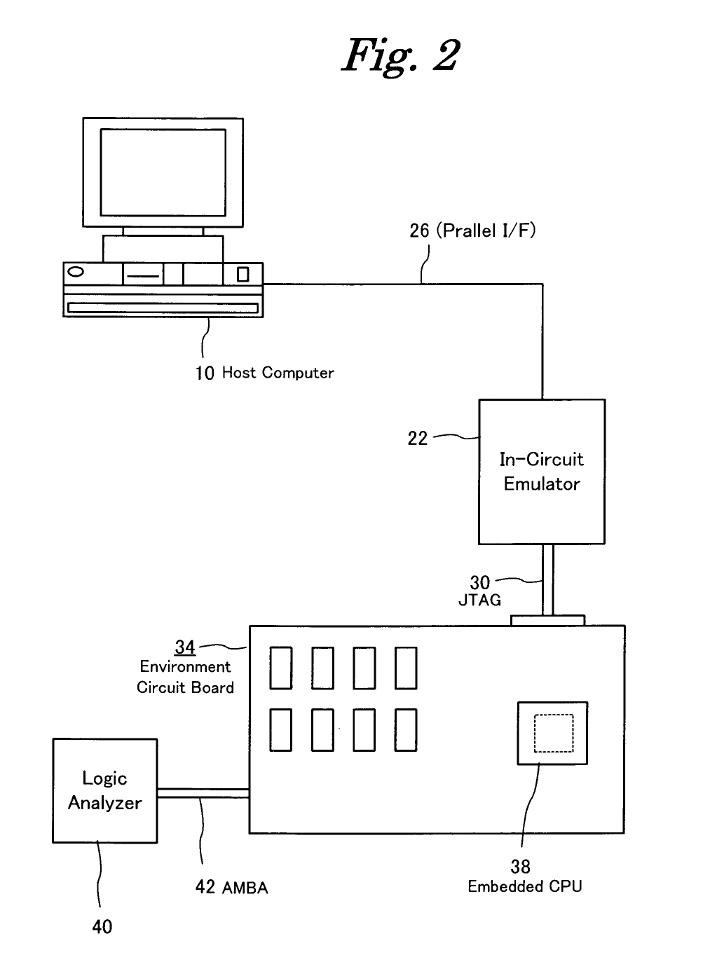

For better understanding of the present invention, a conventional technology is first described in conjunction with FIGS. 1 and 2. FIG. 1 shows a conventional software development environment, which includes a host computer 10; a logic analyzer 12; an environment circuit board 14, on which a CPU 18 is mounted. The host computer 10 and logic analyzer 12 are connected through a RS232C cable 16. The logic analyzer 12 is connected to the CPU 18 on the environment circuit board 14 via probes 20.

According to the above-described software development environment, when the software under development is processed as a task, the logic analyzer 12 measures the processing time of software under development. The probes 20 of the logic analyzer 12 are connected to pins of the CPU 18. Adaptive software for timing measurement is installed in the host computer 10. When the software for timing measurement is executed in the host computer 10, the timing waveform which consists of 1 and 0 is tracked. The waveform record is stored on a memory (not shown), and operating time of the CPU 18 is calculated through the waveform. The processing time of the software can be calculated from the operating time of the CPU 18.

According to the above-described conventional method of using a logic analyzer, the processing time of the task (software under development) is measured when the software is processed as a task; and therefore, it is required to track waveforms by the logic analyzer 12. The calculation or measurement of the processing time is complicated.

FIG. 2 shows another conventional software development environment for ARM (Advanced RISC Machines). “ARM” is a registered trademark of ARM, English company. ARM is a system LSI which uses RISC (Reduced Instruction Set Computer) computer as a core. In FIG. 2, an embedded CPU 38, which includes ARM as a core, is mounted on a development circuit board 34. The development environment further includes a host computer 10; an in-circuit emulator 22; and a logic analyzer 40.

The ICE (In-Circuit Emulator) 22 for ARM is connected through a parallel interface 26 to the host computer 10. The ICE 22 is also connected to the development circuit board 34 through a JTAG (Joint Test Action Group) interface 30.

The logic analyzer (LA) 40 is combinable with the development circuit board 34 through a bus AMBA 42 for ARM. When processing the software under development as a task under this development environment, there are two methods in measurement of the processing time. One is a method using the logic analyzer 22 as usual. Another method is a method of executing a software development tool (Software Development Toolkit) on the host computer 10, and measuring the benchmark value of the CPU 38.

According to the conventional system shown in FIG. 2, the system (development environment) would be expensive. It is hard to know the processing capability of the CPU 38. There, the benchmark value of the CPU 38 only shows the relative capability thereof when executing the software under development.

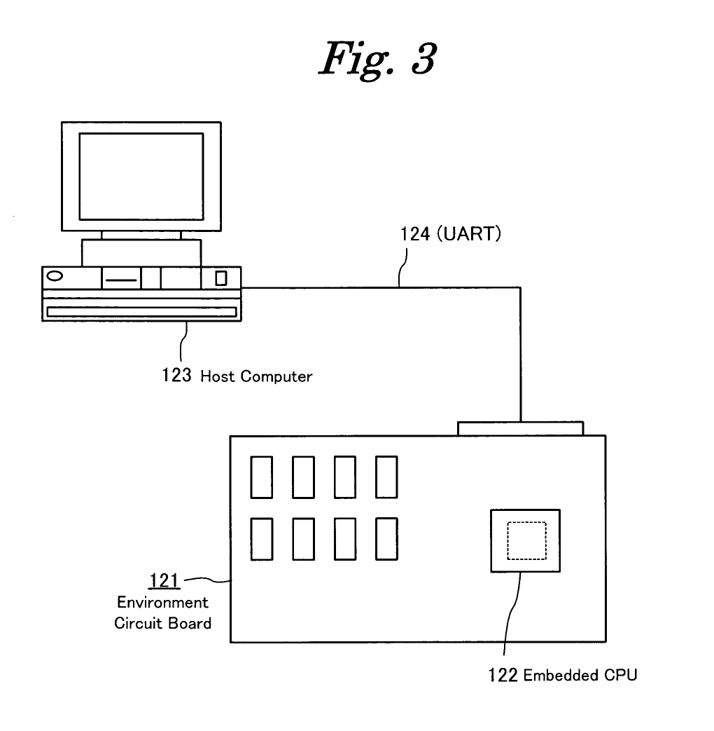

Hereafter, a preferred embodiment of the present invention is described in detail with reference to FIGS. 3 to 5. FIG. 3 shows software development environment according to a preferred embodiment of the present invention. The development environment includes a host computer 123 and a development circuit board 121, on which an embedded CPU 122 is mounted.

In FIG. 3, the embedded CPU 122 includes an ARM core. The host computer 123 is connected through an UART (Universal Asynchronous Receiver-Transmitter) 124 to the development circuit board 121. As compared with the development environment shown in FIG. 2, this development environment is simple and can be called minimum thing as development environment of software.

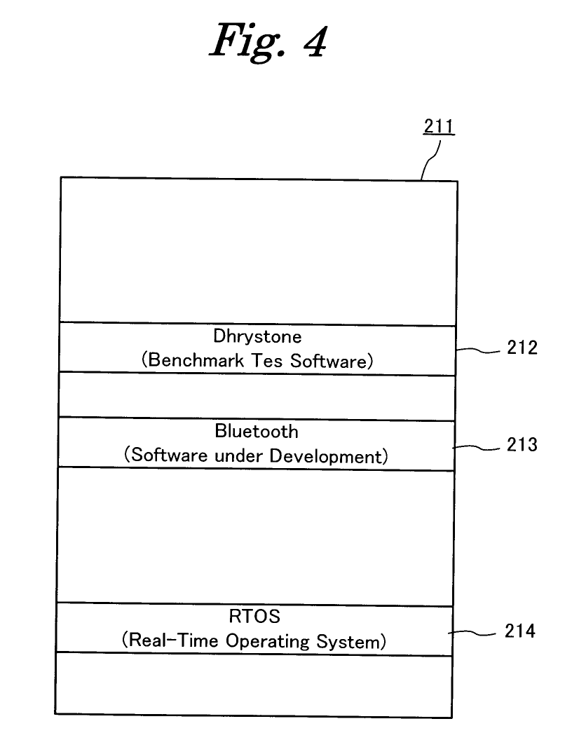

FIG. 4 shows the address configuration of the CPU 122, shown in FIG. 3. On the development circuit board 121, RTOS (Real-Time Operating System) 214 in an address region 211 is executed. An ITRON (Industrial TRON) which is one type of TRON (The Real-Time Operating System Nucleus) is used in this embodiment. ITRON is a real-time operating system, and is suitable for simply controlling operation time of industrial products, such as potable or mobile apparatus. Dhrystone 212 is used as software for benchmark test. Such Dhrystone is a typical test program for evaluating the operation performance of CPU, and was announced by U.S. CACM (Communications of the Association for Computing) in 1984. Dhrystone is a benchmark program that tests a variety of functions. The measure of a computer's speed in Dhrystones per second means the number of times the test program can be run in one second.

The operation performance of the CPU 122 is expressed with MIPS (Million Instructions Per Second) value. However, Dhrystone MIPS value on the basis of computer VAX-11/780 of DEC Corporation may be used. When Dhrystone is executed on the development circuit board 121 for evaluation, the performance of the CPU 122 in the concerned development environment can be investigated. A reference numeral 213 represents software under development, such as Bluetooth, which is a trademark owned by Telefonaktiebolaget L M Ericsson in Sweden. Bluetooth was originally proposed by Ericsson of Sweden in 1994 as a communication standard of car telephones.

Bluetooth is an evolving short-range networking protocol for connecting different types of devices; for example, connecting a mobile phone with a desktop or notebook computer, accessing the Internet via the phone's mobile data system, and even linking the user's voice to the computer. Bluetooth provides low power consumption and low cost. Now, Bluetooth was extended to the standard of the radio card of computer etc. after that, and has developed. In this embodiment the software under development 213 is for controlling PCMA (Personal Computer Memory Card International Association) cards specifically used for notebook type of personal computers.

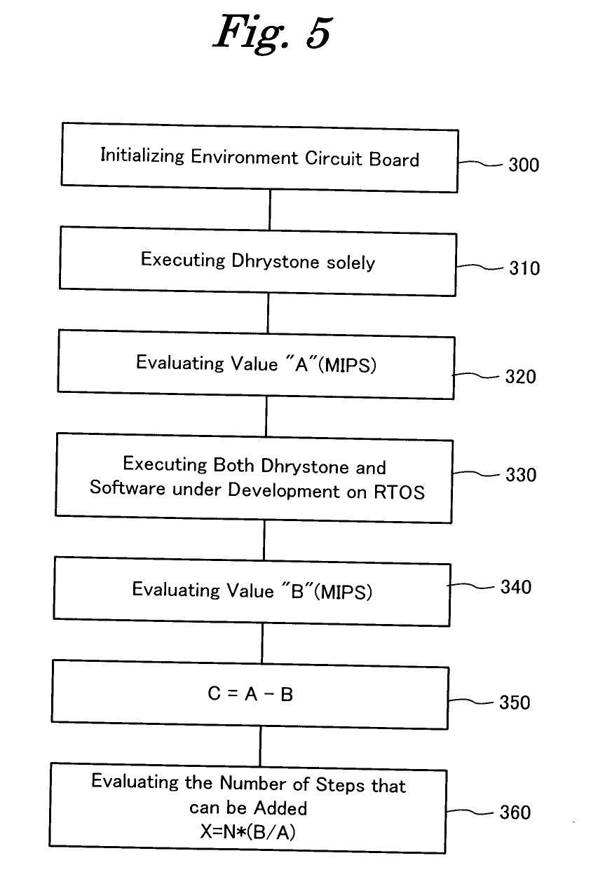

FIG. 5 shows the operation steps according to the preferred embodiment of the present invention. In this embodiment, how new functions of the software 213 is added to the original program will be explained. In Step 300, the development circuit board 121 is initialized, but RTOS is not yet executed. That is because; the purpose of the first phase measures the total capability of the CPU 121 on the development circuit board 121. In Step 320, as the first phase, Dhrystone is independently executed without OS (RTOS) and MIPS value in that case (here A=12 MIPS) is calculated. In order to execute Dhrystone without OS, the C-language compiler with which ARM is equipped is used. It is because the ARM itself and Dhrystone are also constructed by the C language.

Here, Dhrystone (benchmark software) may be performed on RTOS in this first phase 310, and the MIPS value may be calculated as well. However, calculated MIPS value will not be having measured the total capability of CPU 122 on the development circuit board 121, but will become the thing also including RTOS. For example, the processing will become what cannot be disregarded when RTOS is operating a timer.

However, the outline value of the remaining capability of the CPU 122 can be calculated also by this method, and it is simpler than the method using the above-mentioned C-language compiler. This kind of process (method) can be used not only by a developer but also by a customer and that of this method is convenient for the both sides of developer and customer. Since execution of Bluetooth on RTOS, which will be described next, is the environment itself to which a customer actually performs the application program, the meaning of the MIPS value will become more exact at the point of the remaining capability of CPU 122.

Now, in the following step 330, ITRON is executed to prepare environment under which Bluetooth and Dhrystone can be performed. Both of the Bluetooth (software under development) and Dhrystone (Benchmark software) are performed on RTOS in the second phase here. The software under development is executed preferentially. It is important that perform as a task of top priority of Bluetooth, and Dhrystone makes a priority the lowest grade and performs it simultaneously. Dhrystone is used to evaluate the remaining capability of the CPU 122 and to find an addition functions to be added to the original program. MIPS value (here B=5 MIPS) in this step becomes the standard which plans the remaining capability of the CPU 122, as shown in Step 340.

Here, as shown in Step 350 of FIG. 5, Bluetooth occupies a part “C” of CPU capability (C=A−B=7 MIPS), but still has room or capacity to accept a customer's new proposal of additional functions.

Here—it must be noted—these value is only the standard that shows the remaining capability of the CPU 122. Bluetooth and Dhrystone are performed on RTOS, and, usually remarkable processing is performed at RTOS per management matter of the change for processing of multitasking, or others. Even if Bluetooth is executed as a task of top priority, it does not result in the priority of kernel processing of RTOS. An Operating System suitable to mobile apparatus such as ITRON has a lighter load, so that the OS is not heavy enough to have an affect on the effectiveness of this invention. The value near actual CPU remaining capability could be measured, since environment under which Bluetooth is executed on RTOS is the environment itself to which a customer actually performs the application program, as described above.

Step 360 in FIG. 5 shows how the remaining capability of the CPU 122 is calculated concretely. The remaining capability “X” of the CPU 122 in which further functions can be newly added to the software under development is represented by the equation “X=(B/A)*100[%]”. It will be said that there is remaining capability of the number of steps which specifically multiplied the number of steps of Bluetooth by the above-mentioned rate “X”.

It is necessary to also regard most that this number of steps is not the number of steps in the code of software under development but the number of the processing steps of CPU like ARM core. In the case of RISC machine, this number of steps will be called the number or machine cycle of a micro command. In order to convert the CPU steps into the number of code steps, it is necessary to divide the CPU steps with the number of mean micro commands of a macro command of RISC machine, or with the number of mean machine cycles. Though there is remaining power or capability of CPU, there are also many restrictions in a hardware side by mobile or small size of apparatus, and it cannot be overemphasized that there must be additional room in RAM or an address space.

According to the present invention, a second benchmark value is measured when only a benchmark software (Dhrystone) is independently executed and a first benchmark value is measured when both the benchmark software (Dhrystone) and software under development (Bluetooth) are executed. These two (first and second) different benchmark values are compared to evaluate the remaining capability of CPU 122 and to find out how much more functions can be added to the software under development. The method according to the present invention does not need direct measurement compared with the method of measuring the processing time of the task using the conventional logic analyzer, but it can be said that it is a simple and smart way.

Moreover, the demand referred to as it not only saying that the method using the conventional emulator is expensive, but wanting to know the residual capability of CPU that remained for the customer is not met directly. There, the benchmark of CPU showed the relative capability of CPU when executing the software under development. On the other hand, the present invention meets directly the demand, which says that the residual capability of CPU that remained for the customer. Moreover, when a benchmark test software (Dhrystone) is executed on RTOS, the outline value of remaining capability of CPU can be calculated still easily.

1. A software development environment, comprising:
a development board;
an electronic processor based device which is mounted on the development board and is adapted to execute a series of software instructions; and
a host computer which is combinable with the electronic processor based device, wherein
the host computer executes simultaneously a benchmark test software and a software under development both on an operating system to calculate a first benchmark value of the electronic processor based device, so that the residual capability of the electronic processor based device is calculated in accordance with the first benchmark value, the software under development being executed preferentially.

2. A software development environment according to claim 1, wherein
the host computer calculates an amount of new functions that can be added to the software under development in accordance with the first benchmark value.

3. A software development environment according to claim 1, wherein
the host computer solely executes the benchmark test software to calculate a second benchmark value of the electronic processor based device, so that the residual capability of the electronic processor based device is calculated in accordance with the first and second benchmark values.

4. A software development environment according to claim 3, wherein
the host computer calculates an amount of new functions that can be added to the software under development in accordance with the first and second benchmark values.

5. A software development environment according to claim 1, wherein
the operating system is an ITRON (Industrial TRON) which is one type of TRON (The Real-Time Operating System Nucleus).

6. A software development environment according to claim 1, wherein
the electronic processor based device is an embedded CPU.

7. A software development environment according to claim 1, wherein
the host computer is connected through an UART (Universal Asynchronous Receiver-Transmitter) to the development circuit board.

8. A software development environment according to claim 1, wherein
each of the first and second benchmark values are expressed with MIPS (Million Instructions Per Second) value.

9. A software development environment according to claim 1, wherein
the software under development is a wireless communication related software.

10. A software development environment, comprising:
a development board used for developing a wireless communication related software;
an embedded CPU mounted on the development board and is adapted to execute a series of software instructions; and
a host computer which is combinable with the embedded CPU, wherein
the host computer executes simultaneously a benchmark test software and the wireless communication related software both on an operating system to calculate a first benchmark value of the embedded CPU, the wireless communication related software being executed preferentially;
the host computer solely executes the benchmark test software to calculate a second benchmark value of the embedded CPU;
the host computer calculates the residual capability of the embedded CPU in accordance with the first and second benchmark values.
the operating system is ITRON (Industrial TRON), which is one type of TRON (The Real-Time Operating System Nucleus); and
each of the first and second benchmark values being expressed with MIPS (Million Instructions Per Second) value.

11. A method for analyzing software performance, comprising the steps of;
simultaneously executing a benchmark test software and a software under development both on an operating system to calculate a first benchmark value of an electronic processor based device, mounted on a development circuit board, the software under development being executed preferentially;
calculating the residual capability of the electronic processor based device in accordance with the first benchmark value.

12. A method according to claim 11, further comprising the step of:
calculating an amount of new functions that can be added to the software under development in accordance with the first benchmark value.

13. A method according to claim 11, further comprising the steps of:
solely executing the benchmark test software to calculate a second benchmark value of the electronic processor based device; and
calculating the residual capability of the electronic processor based device in accordance with the first and second benchmark values.

14. A method according to claim 13, further comprising the step of:
calculating an amount of new functions that can be added to the software under development in accordance with the first and second benchmark values.

15. A method according to claim 11, wherein
the operating system is an ITRON (Industrial TRON) which is one type of TRON (The Real-Time Operating System Nucleus).

16. A method according to claim 11, wherein
the electronic processor based device is an embedded CPU.

17. A method according to claim 11, wherein
each of the first and second benchmark values are expressed with MIPS (Million Instructions Per Second) value.

18. A method according to claim 11, wherein
the software under development is a wireless communication related software.

19. A method for analyzing software performance, comprising the steps of:
providing a development board used for developing a wireless communication related software;
providing an embedded CPU mounted on the development board and is adapted to execute a series of software instructions;
providing a host computer which is combinable with the embedded CPU;
simultaneously executing a benchmark test software and a wireless communication related software both on an operating system to calculate a first benchmark value of the embedded CPU, the wireless communication related software being executed preferentially;
solely executing the benchmark test software to calculate a second benchmark value of the embedded CPU; and
calculating the residual capability of the embedded CPU in accordance with the first and second benchmark values so as to calculate an amount of new functions that can be added to the wireless communication related software in accordance with the first and second benchmark values, wherein
the operating system is ITRON (Industrial TRON), which is one type of TRON (The Real-Time Operating System Nucleus).
